(19) United States
(12) Patent Application Publication
(10) Pub. No.: US 2026/0322161 A1
(43) Pub. Date: Oct. 15, 2026

(54) MULTIPLE INPUT-MULTIPLE OUTPUT RADIO FREQUENCY POWER HARVESTER

(71) Applicant: QUALCOMM Incorporated, San Diego, CA (US)

(72) Inventors: Xiaojie WANG, Hillsborough, NJ (US); Luanxia YANG, Beijing (CN); Xiaoxia ZHANG, San Diego, CA (US); Junyi LI, Greentown, PA (US)

(21) Appl. No.: 19/111,164

(22) PCT Filed: Dec. 2, 2022
(86) PCT No.: PCT/CN2022/136111

§ 371 Date: Mar. 12, 2025

(51) Int. Cl. H02J 50/00; H02J 50/20; H02J 50/40

(52) U.S. Cl. CPC H02J 50/001; H02J 50/20; H02J 50/402

(57) ABSTRACT

Various aspects of the present disclosure generally relate to wireless communication. An apparatus may include at least two antennas and a signal combiner component that includes at least two combiner inputs. Each combiner input may be electrically coupled to a respective antenna of the at least two antennas. The apparatus may include a rectifier component that includes a rectifier input that is electrically coupled to a combiner output of the signal combiner component.

### FIELD OF THE DISCLOSURE

Aspects of the present disclosure generally relate to wireless communication and to techniques and apparatuses for a multiple-input-multiple-output (MIMO) radio frequency (RF) power harvester.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to an apparatus for harvesting power. The apparatus may include and/or electrically couple to at least two antennas, a signal combiner component, and a rectifier component. The signal combiner component may include at least two combiner inputs, and each combiner input may be electrically coupled to a respective antenna of the at least two antennas. Alternatively or additionally, the rectifier component includes a rectifier input that is electrically coupled to a combiner output of the signal combiner component. The at least two antennas, the signal combiner component, and the rectifier component may enable the apparatus to capture power from a received wireless signal. In some aspects, the apparatus may be a user equipment (UE) or a UE may include the apparatus.

Some aspects described herein relate to an apparatus for harvesting power. The apparatus may include and/or electrically couple to at least two antennas, at least two rectifier components, and a signal combiner component. Each rectifier component may be electrically coupled to one or more antennas of the at least two antennas. Alternatively or additionally, the signal combiner component may be electrically coupled to at least one rectifier component of the at least two rectifier components. The at least two antennas, the at least two rectifier components, and the signal combiner component may enable the apparatus to capture power from a received wireless signal. In some aspects, the apparatus may be a UE or a UE may include the apparatus.

Some aspects described herein relate to an apparatus for harvesting power. The apparatus may include and/or electrically couple to at least two antennas, at least two power splitter components, and at least two rectifier components. In some aspects, each power splitter component may be electrically coupled to one or more antennas of the at least two antennas. Alternatively or additionally, each rectifier component may be electrically coupled to one or more power splitter components. The at least two antennas, the at least two power splitter components, and the at least two rectifier components may enable the apparatus to capture power from a received wireless signal.

Some aspects described herein relate to a method for harvesting power. The method may include receiving, based at least in part on using at least two antennas, at least a first signal and a second signal. The method may include generating a combined signal that includes at least the first signal and the second signal based at least in part on using a signal combiner component that includes at least two combiner inputs, each combiner input being electrically coupled to a respective antenna of the at least two antennas. The method may include rectifying the combined signal based at least in part on using a rectifier component that includes a rectifier input electrically coupled to a combiner output of the signal combiner component.

Some aspects described herein relate to a method for harvesting power. The method may include receiving, based at least in part on using at least two antennas, at least a first signal and a second signal. The method may include rectifying, based at least in part on using at least two rectifier components, at least the first signal and the second signal to generate at least a first rectified signal and a second rectified signal, each rectifier component being electrically coupled to one or more antennas of the at least two antennas. The method may include combining at least the first rectified signal and the second rectified signal based at least in part on using a signal combiner component that is electrically coupled to at least one rectifier component of the at least two rectifier components.

Some aspects described herein relate to a method for harvesting power. The method may include receiving, based at least in part on using at least two antennas, at least a first signal and a second signal. The method may include splitting, based at least in part on using at least two power splitter components, at least the first signal and the second signal to generate a first set of signal partitions and a second set of signal partitions, respectively, each power splitter component being electrically coupled to one or more antennas of the at least two antennas. The method may include rectifying at least the first set of signal partitions and the second set of signal partitions based at least in part on using at least two rectifier components, each rectifier component being electrically coupled to one or more power splitter components of the at least two power splitter components.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example of a passive UE, in accordance with the present disclosure.

FIG. 4 is a diagram illustrating an example of a multiple-input-multiple-output (MIMO) radio frequency (RF) power harvester component, in accordance with the present disclosure.

FIG. 5 is a diagram illustrating an example of a MIMO RF power harvester, in accordance with the present disclosure.

FIG. 6 is a diagram illustrating an example of a MIMO RF power harvester, in accordance with the present disclosure.

FIGS. 7A and 7B are diagrams illustrating, respectively, examples of a first MIMO RF power harvester component and a second MIMO RF power harvester component, in accordance with the present disclosure.

FIGS. 8A, 8B, 8C, and 8D are diagrams illustrating, respectively, examples of a first MIMO RF power harvester component, a second MIMO RF power harvester component, a third MIMO RF power harvester component, and a fourth MIMO RF power harvester component, in accordance with the present disclosure.

FIG. 9 is a diagram illustrating an example process performed, for example, by an apparatus, in accordance with the present disclosure.

FIG. 10 is a diagram illustrating an example process performed, for example, by an apparatus, in accordance with the present disclosure.

FIG. 11 is a diagram illustrating an example process performed, for example, by an apparatus, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

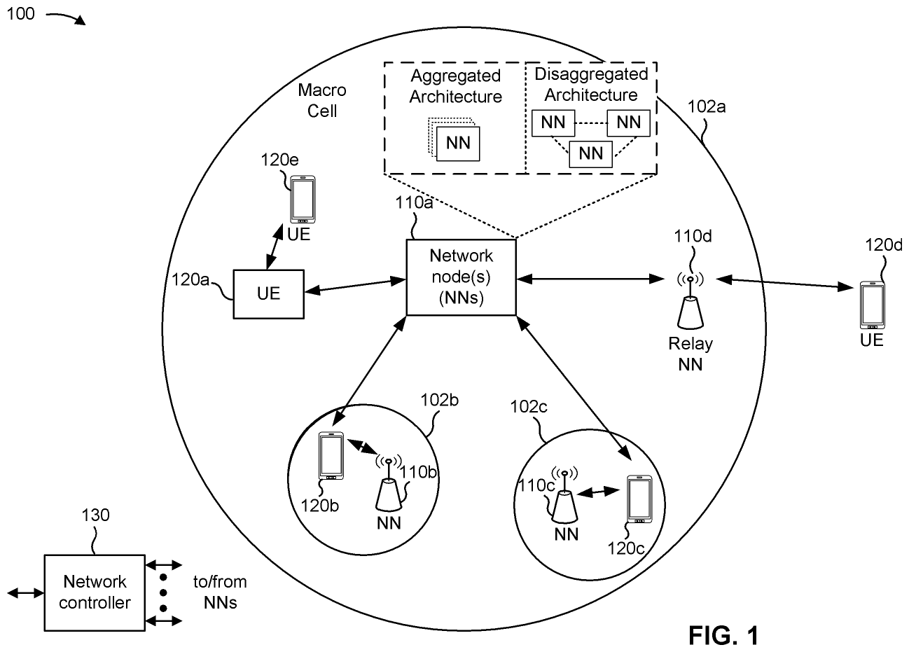

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUS)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

As indicated above, FIG. 1 is provided as an example. Other examples may differ from what is described with regard to FIG. 1.

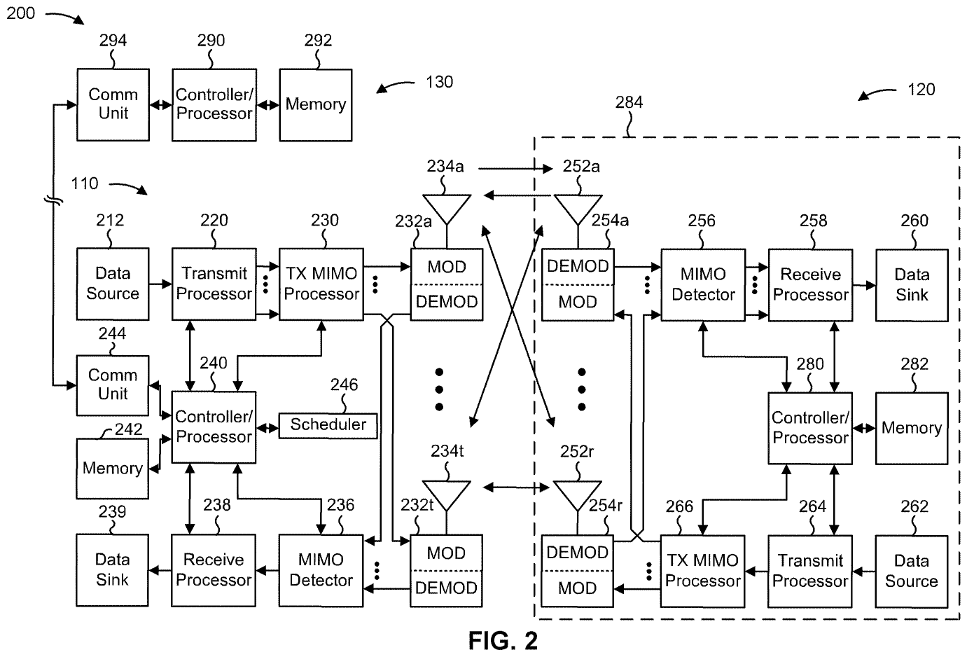

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency (RF) components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

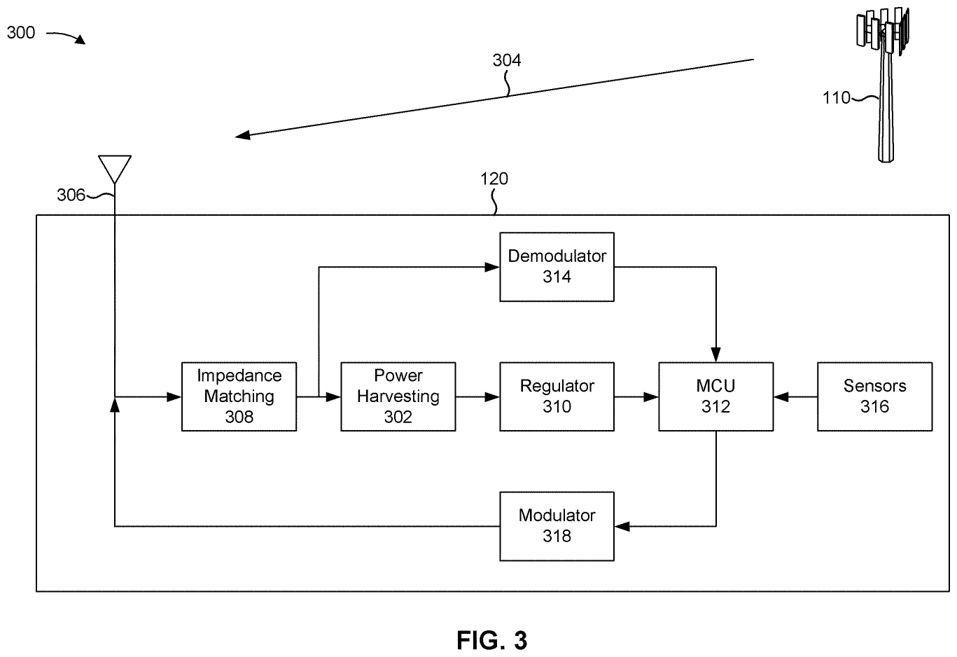

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 3-11).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 3-11).

The controller/processor 240 of the network node 110, the controller/processor 280 of the UE 120, and/or any other component(s) of FIG. 2 may perform one or more techniques associated with a MIMO radio frequency (RF) power harvester, as described in more detail elsewhere herein. In some aspects, the MIMO RF power harvester described herein is included in the network node 110 and/or the UE 120. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. In some examples, executing instructions may include running the instructions, converting the instructions, compiling the instructions, and/or interpreting the instructions, among other examples.

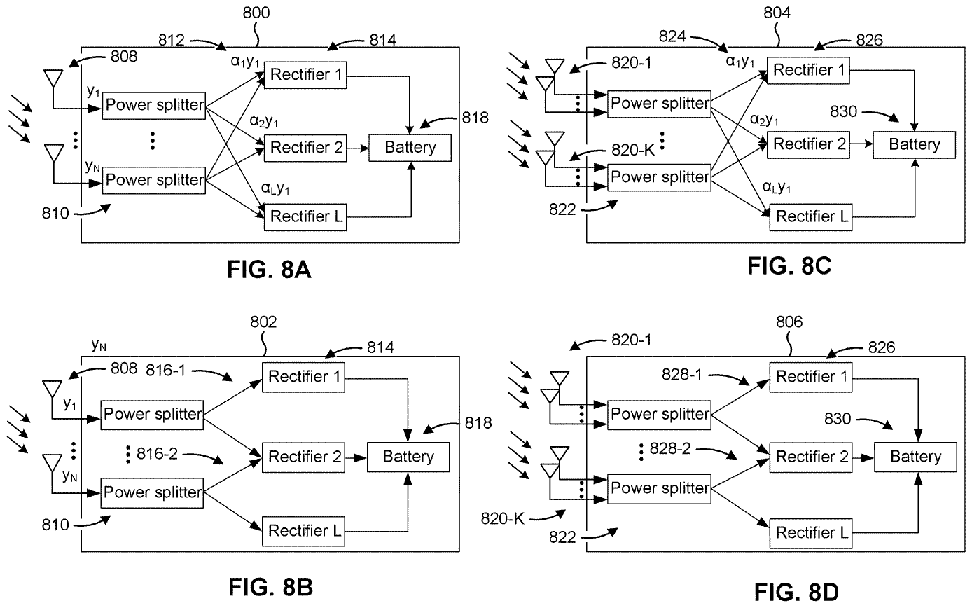

In some aspects, a MIMO RF power harvesting component may include means for receiving multiple signals, such as described with regard to FIGS. 3-11. Alternatively or additionally, the MIMO RF power harvesting component includes means for combining the multiple signals, such as that described with regard to FIGS. 3-8D. The MIMO RF power harvesting component may include means for rectifying one or more signals as described with regard to FIGS. 3-11. In some aspects, the MIMO RF power harvesting component may include means for splitting one or more received signals as described with regard to FIGS. 8A-8D.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

FIG. 3 is a diagram illustrating an example 300 of a passive UE, in accordance with the present disclosure.

A wireless communication system, such as a 5G wireless communication system, may include support for communicating with a passive device, such as a radio frequency identification (RFID) device and/or a passive IoT device. To illustrate, a network node operating in the wireless communication system may be configured to read information from and/or write information to a passive device. An active device and/or active component (e.g., a semiconductor device, a voltage source, and/or an operational amplifier) may add and/or transfer energy into a circuit. A passive device and/or passive component (e.g., a resistor, a capacitor, and/or a diode) may store and/or consume energy. Accordingly, in some aspects, “passive device” may denote a device without an external energy source and/or a device configured to use environmental energy for an energy supply.

To illustrate, the example 300 includes a network node 110 and a UE 120. In the example 300, the UE 120 is shown as a passive UE that includes a power harvesting component 302 that includes an electronic circuit to convert energy from an input signal 304 (e.g., a downlink signal from the network node 110) received via an antenna 306 to an energy source for one or more components included in the UE 120. For example, the power harvesting component 302 may include a diode that is electrically coupled to a capacitor. The power harvesting component 302 may receive the input signal 304 based at least in part on an antenna 306 and/or an impedance matching circuit 308. As shown by the example 300, the power harvesting component 302 may electrically couple to a regulator component 310 that outputs a fixed voltage for powering a microcontroller unit 312 (shown as MCU 312). As one example, the regulator component 310 may convert an input alternating current (AC) signal to a direct current (DC) signal. The microcontroller unit 312 may process input from a demodulator component 314 (e.g., that demodulates the input signal 304) and/or one or more sensors 316. In some aspects, the microcontroller unit 312 may generate an output that is input to a modulator component 318 and transmitted by the UE 120 to the network node 110. While the example 300 shows the UE 120 as including a demodulator component 314 and a modulator component 318, other examples of a passive UE may not include the demodulator component 314 and/or the modulator component 318. For example, a passive UE implemented as a passive IoT device and/or a passive RFID may include a diode, a capacitor, a resistor, and a switch to generate a backscatter signal (e.g., a reflected signal) that includes modulated information. A “semi-passive” device may include a battery that is charged by the device based at least in part on the (converted) environmental energy.

In some aspects, how a wireless communication system (e.g., a 5G wireless communication system) communicates with a passive UE may result in inefficient power harvesting by the passive UE. To illustrate, a power associated with an output signal by a power harvester component included in the passive UE may be based at least in part on diode behavior that is relative to characteristics associated with an input signal. For example, for a first range of input voltages and/or signals, the diode may output a first output signal with higher power relative to a second output signal that is associated with a second range of input voltages and/or signals. Accordingly, an output signal (and/or a power level associated with the output signal) may vary based at least in part on a diode and the diode's operating characteristics. As another example, power harvesting by an RFID passive UE and/or an IoT passive UE may be configured to work when operating 10 meters or less from a network node based at least in part on a link budget. That is, the device may successfully capture power from an environment based at least in part on operating within 10 meters of the transmitting device, and may be inoperative outside that operating range. Alternatively or additionally, the power harvesting circuitry may be configured to operate at an input power of −13 decibel milliwatts (dBm) such that a lower input power (e.g., −20 dBm) may be insufficient to operate the power harvesting circuitry. As yet another example, the higher frequencies associated with some wireless communication systems (e.g., above 6 GHz) may be more susceptible to multi-path fading that results in decreased input signal power to the power harvester. Accordingly, various factors may render a passive UE inoperable.

Some techniques and apparatuses described herein provide a MIMO RF power harvester. In some aspects, a MIMO RF power harvester may include at least two antennas, a signal combiner component, and a rectifier component. Alternatively or additionally, the MIMO RF power harvester may include at least two inputs that enable the MIMO RF power harvester to electrically couple to the at least two antennas. The signal combiner component may include at least two combiner inputs, and each combiner input may be electrically coupled to a respective antenna of the two (or more) antennas. That is, the signal combiner may be configured to receive multiple input signals and generate a combined signal based at least in part on the multiple input signals. The rectifier component may include a rectifier input that is electrically coupled to a combiner output of the signal combiner component. In some aspects, the rectifier component may receive, as the combined signal, an AC signal, and output a DC signal that is based at least in part on the AC signal. In some aspects, the MIMO RF power harvester may be included in a UE.

In some aspects, a MIMO power harvester may include at least two antennas, at least two rectifier components, and a signal combiner component. Alternatively or additionally, the MIMO RF power harvester may include at least two inputs that enable the MIMO RF power harvester to electrically couple to the at least two antennas. Each rectifier component of the at least two rectifier components may be electrically coupled to one or more antennas of the at least two antennas. To illustrate, a rectifier component and an antenna may be electrically coupled based at least in part on a one-to-one connection between the rectifier component and the antenna. As another example, the at least two antennas may be partitioned into at least a first antenna group and a second antenna group. Each antenna in the first antenna group may be electrically coupled to a first rectifier component of the at least two rectifier components, and/or each antenna in the second antenna group may be electrically coupled to a second rectifier component of the at least two rectifier components. In some aspects, each rectifier component includes a respective rectifier output that is electrically coupled to the signal combiner component. In some aspects, the MIMO RF power harvester may be included in a UE.

In some aspects, a MIMO RF power harvester may include at least two antennas, at least two power splitter components, and at least two rectifier components. Alternatively or additionally, the MIMO RF power harvester may include at least two inputs that enable the MIMO RF power harvester to electrically couple to the at least two antennas. Each power splitter component may be electrically coupled to one or more antennas of the at least two antennas (e.g., based at least in part on a one-to-one connection or based at least in part on a group of antennas). Alternatively or additionally, each power splitter may be electrically coupled to one or more rectifier components of the at least two rectifier components. In some aspects, the MIMO RF power harvester may be included in a UE.

By receiving input signals based at least in part on multiple antennas, a MIMO RF power harvester may generate a combined signal that has a higher peak-to-average-power ratio (PAPR) relative to a single antenna. As one example, a power associated with the combined signal may have an average power of N×P (where N is an integer and P is an average power of a single signal) relative to P associated with a single antenna. As another example, the use of multiple antennas, and multiple signals associated with the multiple antennas, may provide more diversity in the received signals and, subsequently, a lower probability of fading relative to a signal received by a single antenna. Accordingly, the combined signal may enable a passive UE to harvest power and/or energy in wireless communications systems that operate at higher frequencies (e.g., that may be more susceptible to multi-path fading) and/or increase an operating range of the passive UE from the network node.

As indicated above, FIG. 3 is provided as an example. Other examples may differ from what is described with regard to FIG. 3.

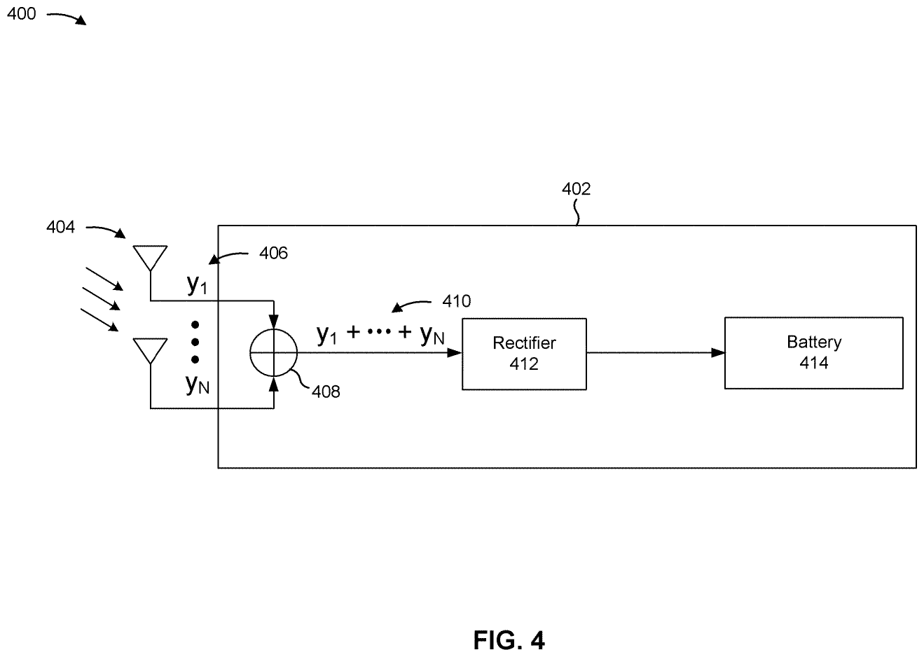

FIG. 4 is a diagram illustrating an example 400 of a MIMO RF power harvester component 402, in accordance with the present disclosure. In some aspects, the MIMO RF power harvester component 402 may be included in a UE (e.g., the UE 120).

As shown by the example 400, the MIMO RF power harvester component 402 may be implemented as a passive device that includes one or more passive components, such as a resistor, a capacitor, and/or a diode. Alternatively, the MIMO RF power harvester component 402 may be implemented as a semi-passive device that includes a battery that is charged by the device based at least in part on collected energy. The MIMO RF power harvester component 402 may be electrically coupled to multiple antennas 404 that are shown as including N antennas, where N is an integer. In some aspects, the multiple antennas 404 may be included as part of the MIMO RF power harvester component 402, while in other examples, the multiple antennas 404 may be external to the MIMO RF power harvester component 402. For example, the MIMO RF power harvester component 402 may electrically couple to one or more impedance matching circuits, as shown by the power harvesting component 302, and the impedance matching circuit 308 as described with regard to FIG. 3, and each impedance matching circuit may be electrically coupled to a respective antenna of the multiple antennas 404. That is, each impedance matching circuit may be electrically coupled to an antenna based at least in part on a one-to-one connection. Accordingly, and as shown by the example 400, the MIMO RF power harvester component 402 may receive N input signals 406 (shown by FIG. 4 as y₁ to y_{N}).

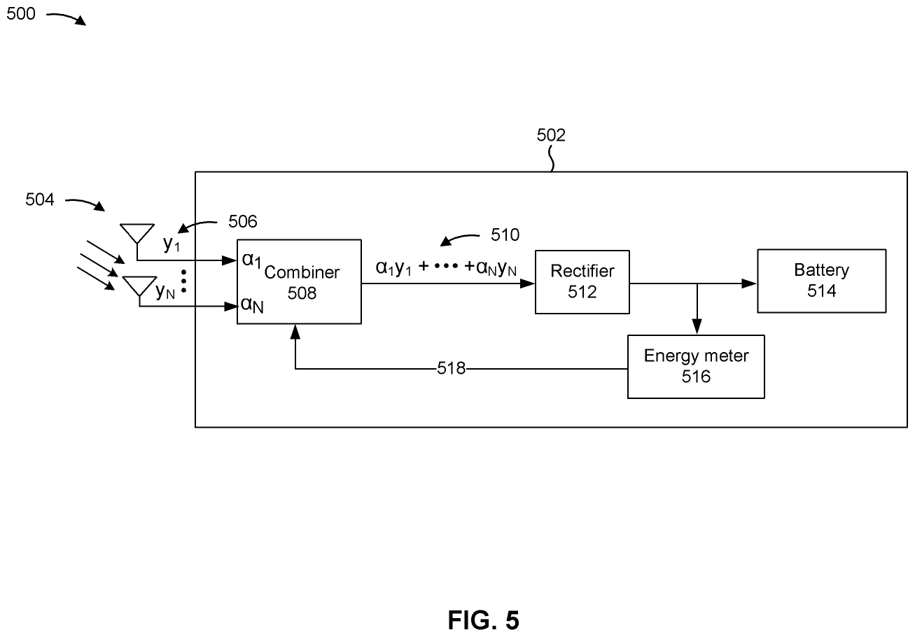

The MIMO RF power harvester component 402 may include a signal combiner component 408. In some aspects, the signal combiner component 408 may be a passive signal combiner that includes one or more passive components and/or does not include an active component. For example, the signal combiner component may include multiple resistors that are electrically coupled in a configuration that sums a first input signal with a second input signal. To illustrate, the signal combiner component 408 may generate a combined signal 410 based at least in part on combining multiple analog input signals in time. For instance, if a first input signal is a first analog sine wave and a second input signal is a second analog sine wave, the combined output signal would be a single analog combined output signal that is based at least in part on combining both the first analog sine wave and the second analog sine wave. In some aspects, the signal combiner component 408 may be referred to as a “basic signal combiner” and/or a “simple signal combiner” based at least in part on the signal combiner component 408 including (only) the capability to combine input signals as received and excluding other processing functionality. For instance, a more complex signal combiner, such as described with regard to FIG. 5, may include more processing functionality (e.g., scaling functionality, feedback input, and/or dynamic scaling) relative to the signal combiner component 408.

As shown by the example 400, the signal combiner component 408 may be electrically coupled to a rectifier component 412. For instance, a combiner output of the signal combiner component may couple to a rectifier input of the rectifier component 412, and the signal combiner component 408 may input the combined signal 410 to the rectifier component. In some aspects, the rectifier component 412 may be implemented as a passive rectifier component that includes one or more passive components and excludes any active components. To illustrate, the rectifier component 412 may include one or more diodes, a resistor, and/or a capacitor. In some aspects, the rectifier component 412 may convert an AC signal to a DC signal. Alternatively or additionally, the combined signal 410 may cause the rectifier component 412 to generate a first output signal that has a higher PAPR relative to a second output signal that is based at least in part on an input signal associated with a single antenna, and increase an amount of power captured by the MIMO RF power harvester component 402 relative to other implementations.

In some aspects, and as shown by the example 400, the MIMO RF power harvester component 402 may include and/or be electrically coupled to a battery 414, such as a rechargeable battery that stores power and/or energy converted by the MIMO RF power harvester component 402. That is, the battery 414 may be external to, or part of, the MIMO RF power harvester component 402. In some examples, the battery 414 may provide energy to a component within the MIMO RF power harvester component 402 and/or a semi-passive UE, such as a demodulator circuit and/or modulator circuit as described with regard to FIG. 3.

As indicated above, FIG. 4 is provided as an example. Other examples may differ from what is described with regard to FIG. 400.

FIG. 5 is a diagram illustrating an example 500 of a MIMO RF power harvester component 502, in accordance with the present disclosure. In some aspects, the MIMO RF power harvester component 502 may be included in a UE (e.g., the UE 120).

As shown by the example 500, the MIMO RF power harvester component 502 may be implemented as a passive device that includes one or more passive components, such as a resistor, a capacitor, and/or a diode. Alternatively, the MIMO RF power harvester component 502 may be implemented as a semi-passive device that includes an active component that may be powered by a battery that is charged by the device based at least in part on collected energy. The MIMO RF power harvester component 502 may electrically couple to multiple antennas 504 that are shown as including N antennas, where N is an integer. In some aspects, the multiple antennas 504 may be included as part of the MIMO RF power harvester component 502, or may be external to the MIMO RF power harvester component 502. As shown by the example 500, the MIMO RF power harvester component 502 may receive N input signals 506 (shown by FIG. 5 as y₁ to y_{N}).

The MIMO RF power harvester component 502 may include a signal combiner component 508 that may be implemented as a passive signal combiner or an active signal combiner. In some aspects, the signal combiner component 508 may be referred to as a “complex signal combiner” that includes processing functionality, such as signal processing functionality that modifies an input signal based at least in part on a non-complex scaling factor, a complex scaling factor, or a phase factor. For instance, and as shown by the example 500, the signal combiner component 508 may receive a first input signal (shown as y₁) from a first antenna of the multiple antennas and generate a first modified signal (shown as α₁y₁) based at least in part on a scaling factor α₁. In some aspects, the signal combiner component 508 may generate a respective modified signal for each respective input signal, and combine each of the modified signals together (e.g., α₁y₁+α₂y₂ . . . α_{N}y_{N}) to generate a combined signal 510.

The signal combiner component 508 may include processing functionality that dynamically selects a respective modification for each respective input signal. In some aspects, the signal combiner component 508 may select one or more modifications for the respective input signals based at least in part on a UE capability. For instance, a UE capability may be associated with an ability to apply a fixed scaling factor, and the signal combiner component 508 may select a fixed scaling factor as a respective modification. Alternatively or additionally, a UE capability may be associated with an ability to apply any combination of a configurable scaling factor, an amplitude scaling factor, a phase scaling factor, and/or a complex-number scaling factor. As another example, the signal combiner component 508 may select one or more modifications based at least in part on feedback from an energy meter as described below. For instance, the signal combiner component 508 may select a modification to an input signal based at least in part on feedback from the energy meter that indicates a rectifier component has been saturated. That is, the processing functionality at the signal combiner component 508 may select a modification that mitigates saturation at the rectifier component. Alternatively or additionally, the processing functionality included in the signal combiner component 508 may select a respective modification for each respective signal based at least in part on optimizing a power level of the combined signal (e.g., a power level that prevents saturation and/or generates a combined signal that will result in increased harvested and/or captured power) relative to another signal.

In some aspects, the signal combiner component 508 may combine the modified signals based at least in part on using one or more combining techniques. To illustrate, the signal combiner component 508 may use non-coherent combining (e.g., combining out-of-phase signals) to generate a summed signal power represented as N*P, coherent combining (e.g., combining in-phase signals) to generate a summed signal power represented as N²*P, and/or diversity combining (e.g., selection diversity combining, equal-gain combining, or maximum-ratio combining) to improve a signal quality and/or signal power of the combined signal. In some aspects, the signal combiner component 508 may include processing functionality that analyzes one or more characteristics associated with the MIMO RF power harvester component 502 to select modification(s) that result in an optimal input power and/or waveform (e.g., for a rectifier component 512) that improves power harvesting and/or mitigates a loss of power.

To illustrate, the MIMO RF power harvester component 502 may have a non-linear characteristic and/or mathematical relation between input power and output power, such as a non-linear output power characteristic that is based at least in part on the rectifier component 512. In some aspects, the signal combiner component 508 may select a modification based at least in part on the non-linear characteristic of the MIMO RF power harvester component 502 and/or the rectifier component 512. For instance, a first input power that is less than a first power threshold may cause the MIMO RF power harvester component 502 and/or the rectifier component 512 to output zero power and/or fail to capture any power. Alternatively or additionally, a second input power between the first power threshold and a second power threshold may result in the MIMO RF power harvester component 502 and/or the rectifier component 512 outputting power that is relative to the second input power. That is, an increase of power associated with the second input power (e.g., between the first power threshold and the second power threshold) may cause the MIMO RF power harvester component 502 and/or the rectifier component 512 to output an increased output power. A third input power that is between the second power threshold and a third power threshold may result in the MIMO RF power harvester component 502 and/or the rectifier component 512 outputting increased power but with less efficiency relative to the second input power. A fourth input power that is larger than the third power threshold may saturate the MIMO RF power harvester component 502 and/or the rectifier component 512 such that an output power efficiency of the MIMO RF power harvester component 502 and/or rectifier component 512 may be significantly less relative to the other input powers. Based at least in part on analyzing the various characteristics of the MIMO RF power harvester component 502 and/or an input power, the signal combiner component 508 may modify the combined signals, such as by attenuating the combined signal to mitigate saturating the rectifier component 512 and/or generating a combined signal with an input power that is between the second power threshold and the third power threshold. For instance, the signal combiner component 508 may select one or more modifications that generate an input signal with a power level associated with the highest output power efficiency (e.g., one or more optimized modifications) of the rectifier 512 (e.g., associated with the second input power between the first power threshold and the second power threshold).

As shown by the example 500, the signal combiner component 508 may be electrically coupled to the rectifier component 512. The rectifier component 512 may be implemented as a passive rectifier component that includes one or more passive components and excludes any active components. In some aspects, and as described above, the combined signal 510 may cause the rectifier component 512 to generate a first output signal that has a higher PAPR relative to a second output signal that is based at least in part on an input signal associated with a single antenna. The higher PAPR may result in an increased amount of power captured by the MIMO RF power harvester component 502 relative to other implementations. Alternatively or additionally, the MIMO RF power harvester component 502 may include and/or may be electrically coupled to a battery 514, such as a rechargeable battery that stores power and/or energy converted by the MIMO RF power harvester component 502. However, in other examples, the MIMO RF power harvester component 502 may be disconnected from a battery.

In some aspects, the MIMO RF power harvester component 502 may include an energy meter component 516 that is electrically coupled to a rectifier output associated with the rectifier component 512. The energy meter component 516 may include a passive circuit and/or an active circuit (e.g., a semi-passive circuit) that is powered based at least in part on the battery 514. As one example, the energy meter component 516 may include a resistor an analog-to-digital converter (ADC) that captures and/or measures a volage across the resistor. As shown by reference number 518, the energy meter component 516 may electrically couple to a combiner input of the signal combiner component 508 and provide feedback associated with an output of the rectifier component. As one example, the energy meter component 516 may indicate a power level associated with the output signal, and the signal combiner component 508 may adjust one or more modifications used for one or more respective input signals to optimize the combined output signal (e.g., optimize a signal power level of the combined output signal that increases a power level and/or mitigates saturation at the rectifier component 512). That is, the signal combiner component 508 may adjust the modification(s) based at least in part on input from the energy meter component 516 to generate a first output signal that has a higher PAPR relative to a second output signal that is based at least in part on an input signal associated with a single antenna. The higher PAPR may increase an amount of power captured by the MIMO RF power harvester component 502 relative to other implementations.

As indicated above, FIG. 5 is provided as an example. Other examples may differ from what is described with regard to FIG. 5.

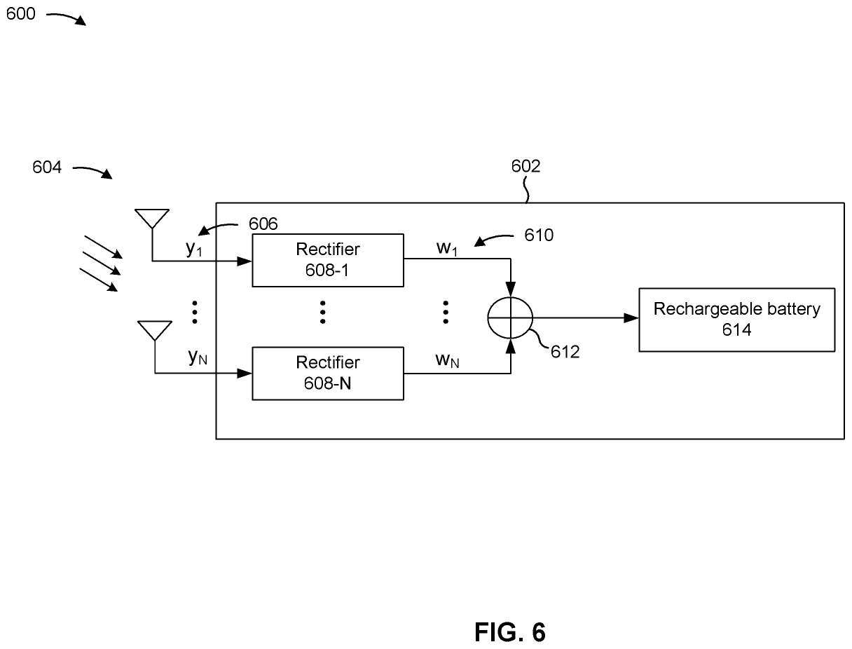

FIG. 6 is a diagram illustrating an example 600 of a MIMO RF power harvester component 602, in accordance with the present disclosure. In some aspects, the MIMO RF power harvester component 602 may be included in a UE (e.g., the UE 120).

As shown by the example 600, the MIMO RF power harvester component 602 may be implemented as a passive device or a semi-passive device. The MIMO RF power harvester component 602 may electrically couple to multiple antennas 604 that are shown as including N antennas. In some aspects, the multiple antennas 604 may be included as part of the MIMO RF power harvester component 602, while in other examples, the multiple antennas 604 may be external to the MIMO RF power harvester component 602. As shown by the example 600, the MIMO RF power harvester component 602 may receive N input signals 606 (shown by FIG. 6 as y₁ to y_{N}).

The MIMO RF power harvester component 602 may include multiple rectifier components (shown as a first rectifier component 608-1 to an N-th rectifier component 608-N). In some aspects, one or more of the multiple rectifier components may be implemented as a passive device that is configured to convert an AC signal to a DC signal. To illustrate, each rectifier component may be electrically coupled to a respective antenna of the multiple antennas 604 (e.g., based at least in part on a one-to-one connection) and receive an input signal from the antenna. For instance, the first rectifier component 608-1 may receive a first input signal y₁, and the N-th rectifier component 608-N may receive an N-th input signal y_{N}. Collectively, the multiple rectifier components may generate multiple output signals 610 (shown as w₁ to w_{N}).

Although the example 600 shows a rectifier component directly connected to an antenna, other examples may electrically couple a rectifier component to an antenna based at least in part on a signal filter. To illustrate, an antenna of the multiple antennas 604 may be configured as a narrowband antenna that transmits and/or receives narrowband filters. Alternatively or additionally, an antenna of the multiple antennas 604 may be configured as a wideband antenna. That is, the narrowband antenna may be configured to receive a first signal within a first frequency band with a first amount of error, and the wideband antenna may be configured to receive a second signal within a second frequency band with a second amount of error. The first frequency band may be different from the second frequency band (e.g., different operating center frequencies) and/or may span fewer frequencies. Alternatively or additionally, a rectifier component may be configured as a narrowband rectifier component (e.g., configured to rectify signals within the first frequency band) or a wideband rectifier component (e.g., configured to rectify signals within the second frequency band). In some aspects, a signal filter may be configured and/or based at least in part on the narrowband antenna (e.g., configured to pass signals in the first frequency band associated with the narrowband and suppress signals outside of the first frequency band) or the wideband antenna (e.g., configured to pass signals in the second frequency band associated with the wideband and suppress signals outside of the second frequency band). Alternatively or additionally, the signal filter may be configured and/or based at least in part on the narrowband rectifier (e.g., configured to pass signals in the first frequency band associated with the narrowband and suppress signals outside of the first frequency band) or the wideband rectifier (e.g., configured to pass signals in the second frequency band associated with the wideband and suppress signals outside of the second frequency band).

As shown by the example 600, the MIMO RF power harvester component 602 may include a signal combiner component 612 that includes multiple combiner inputs, and each combiner input may electrically couple to a rectifier component based at least in part on a one-to-one connection. To illustrate, a first combiner input may electrically couple to a rectifier output associated with the first rectifier component 608-1, and an N-th combiner input may electrically couple to a rectifier output associated with the rectifier component 608-N. The signal combiner component 612 may receive a respective signal from each rectifier component (e.g., a DC signal), and may combine the respective signals together to generate a combined signal. The signal combiner component 612 may be implemented as a passive device or as semi-passive device. In some aspects, the signal combiner component 612 may be implemented as a basic signal combiner and/or a simple signal combiner as described above.

As shown by the example 600, the MIMO RF power harvester component 602 may include and/or be electrically coupled to a battery 614, such as a rechargeable battery that stores power and/or energy converted by the MIMO RF power harvester component 602. The battery 614 may be electrically coupled to one or more components within the MIMO RF power harvester component 602 and/or a semi-passive UE. However, in other examples, the MIMO RF power harvester component 602 may be disconnected from a battery.

As indicated above, FIG. 6 is provided as an example. Other examples may differ from what is described with regard to FIG. 6.

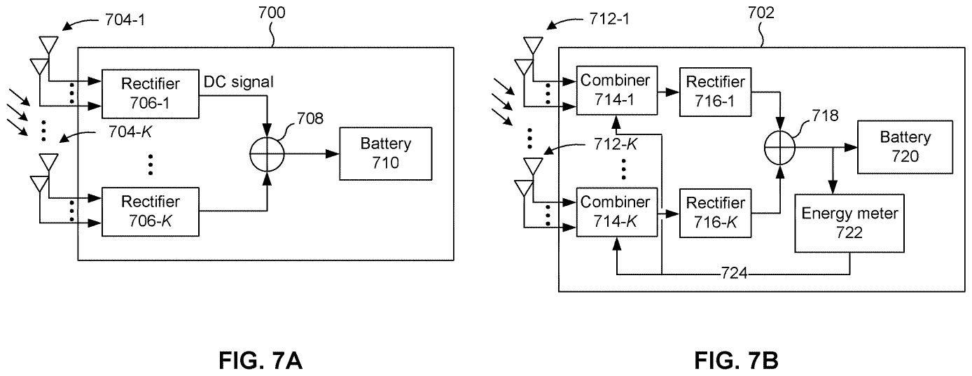

FIGS. 7A and 7B are diagrams illustrating, respectively, examples of a first MIMO RF power harvester component 700 and a second MIMO RF power harvester component 702, in accordance with the present disclosure. In some aspects, the first MIMO RF power harvester component 700 and/or the second MIMO RF power harvester component 702 may be included in a UE (e.g., the UE 120).

FIG. 7A illustrates the first MIMO RF power harvester component 700, which may be implemented as a passive device or a semi-passive device. As shown by FIG. 7A, the first MIMO RF power harvester component 700 may electrically couple to multiple antennas. In some aspects, the multiple antennas may be grouped into K antenna groups, where K is an integer. To illustrate, the multiple antennas may include a first antenna group 704-1 up to a K-th antenna group 704-K. Each antenna group may include a same number of antennas as other antenna groups, or a different number of antennas from other antenna groups. An antenna group may include one or more antennas that are grouped together based at least in part on each antenna in the antenna group being configured with one or more common characteristics, such as a common operating frequency band, a common operating center frequency, and/or a common polarization.

The first MIMO RF power harvester component 700 may include multiple rectifier components (shown as a first rectifier component 706-1 to a K-th rectifier component 706-K). In some aspects, each rectifier component may be implemented as a passive device that is configured to convert an AC signal to a DC signal. As shown by the first MIMO RF power harvester component 700, each rectifier component may include multiple rectifier inputs, where each rectifier input is electrically coupled to an antenna in an antenna group. To illustrate, the first antenna group may include M antennas, and the first rectifier component 706-1 may include M rectifier inputs, where M is an integer. Each rectifier input of the first rectifier component 706-1 may electrically couple to a respective antenna of the first antenna group 704-1 based at least in part on a one-to-one connection. Accordingly, the first rectifier component 706-1 may receive M input signals and generate a first (single) output signal that is based at least in part on a combination of the M input signals. In some aspects, a rectifier output of the first rectifier component 706-1 may be electrically coupled to a combiner input associated with a signal combiner component 708.

The signal combiner component 708 may include multiple combiner inputs as described above, and each combiner input may electrically couple to a rectifier component based at least in part on a one-to-one connection. The signal combiner component 708 may receive, from each rectifier component, an input signal (e.g., a DC signal), and may generate a combined signal that is based at least in part on each of the input signals. In some aspects, the signal combiner component 708 may be implemented as a passive device or a semi-passive device. Alternatively or additionally, the signal combiner component 708 may be implemented as a basic signal combiner and/or a simple signal combiner as described above.

The first MIMO RF power harvester component 700 may include and/or be electrically coupled to a battery 710, such as a rechargeable battery that stores power and/or energy converted by the first MIMO RF power harvester component 700. In some examples, the battery 710 may provide energy to a component included in the first MIMO RF power harvester component 700 and/or a semi-passive UE. However, in other examples, the first MIMO RF power harvester component 700 may be disconnected from a battery.

FIG. 7B illustrates the second MIMO RF power harvester component 702, which may be implemented as a passive device or a semi-passive device. The second MIMO RF power harvester component 702 may electrically couple to multiple antennas that are grouped into K antenna groups, such as a first antenna group 712-1 up to a K-th antenna group 712-K. Each antenna group may include a same number of antennas as other antenna groups, or a different number of antennas from other antenna groups. Alternatively or additionally, each antenna group may include one or more antennas that are grouped together based at least in part on one or more common characteristics, such as a common operating frequency band, a common operating center frequency, and/or a common polarization.

The second MIMO RF power harvester component 702 may include multiple signal combiner components (shown as a first signal combiner component 714-1 to a K-th signal combiner component 714-K). In some aspects, one or more of the multiple signal combiner components may be implemented as a complex signal combiner component that includes processing functionality to modify an input signal (e.g., based at least in part on a scaling factor and/or input from an energy meter). Alternatively or additionally, one or more of the multiple signal combiner components may be implemented as a basic combiner component.

As shown by the second MIMO RF power harvester component 702, each signal combiner component may include multiple signal combiner inputs. To illustrate, the first antenna group 712-1 may include M antennas, and the first signal combiner component 714-1 may include M combiner inputs. Each combiner input of the first signal combiner component 714-1 may electrically couple to a respective antenna of the first antenna group 712-1 (e.g., based at least in part on a one-to-one connection). Accordingly, the first signal combiner component 714-1 may receive M input signals and generate a first combined signal that is based at least in part on the M input signals. As described with regard to FIG. 5, one or more signal combiner components of the multiple signal combiner components may generate the combined signal based at least in part on applying a (respective) modification to each input signal.

In some aspects, the second MIMO RF power harvester component 702 may include multiple rectifier components (shown as a first rectifier component 718-1 to a Kth rectifier component 718-K). Each rectifier component may include a rectifier input that is electrically coupled to a combiner output. For instance, and as shown by the second MIMO RF power harvester component 702, a combiner output of the first signal combiner component 714-1 may electrically couple to a rectifier input of the first rectifier component 716-1, and the first rectifier component 718-1 may generate an output signal based at least in part on a first combined signal generated by the first signal combiner component 714-1.

The second MIMO RF power harvester component 702 may include an additional signal combiner component 718 that, relative to the multiple signal combiner components electrically coupled to the antenna groups, is a basic signal combiner as described above. The additional signal combiner component 718 may include multiple combiner inputs, and each combiner input may electrically couple to a rectifier component based at least in part on a one-to-one connection. The additional signal combiner component 718 may receive a respective signal from each rectifier component, and may generate a combined signal that is based at least in part on the respective signals. In some aspects, the additional signal combiner component 718 may be implemented as a passive device or a semi-passive device.

The additional signal combiner component 718 may electrically couple to a battery 720 (e.g., either internal or external to the second MIMO RF power harvester component 702) and/or an energy meter component 722. As described above, the battery 720 may be a rechargeable battery that stores energy collected by the second MIMO RF power harvester component 702. The energy meter component 722 may be electrically coupled to a combiner output of the additional signal combiner component and, as shown by reference number 724, one or more combiner inputs associated with the multiple signal combiner components. The energy meter component 722 may indicate feedback to one or more of the multiple signal combiner components (e.g., an energy level associated with a combined signal generated by the additional signal combiner component 718), and one or more of the multiple signal combiner components may dynamically adjust a modification to a signal as described above.

By receiving input signals based at least in part on multiple antennas, a MIMO RF power harvester may generate a combined signal that has a higher peak-to-average-power ratio (PAPR) relative to a single antenna. An ability to partition and/or modify an input signal may enable the MIMO RF power harvester to adjust signals in a manner that increases an amount of power extracted by the MIMO RF power harvester (e.g., by selecting optimal modifications that generate a combined signal that best extracts power relative to other combined signals associated with other modifications). Accordingly, the combined signal may enable a passive UE to harvest power and/or energy in wireless communications systems that operate at higher frequencies (e.g., that may be more susceptible to multi-path fading) and/or increase an operating range of the passive UE from the network node.

As indicated above, FIGS. 7A and 7B are provided as examples. Other examples may differ from what is described with regard to FIGS. 7A and 7B.

FIGS. 8A, 8B, 8C, and 8D are diagrams illustrating, respectively, examples of a first MIMO RF power harvester component 800, a second MIMO RF power harvester component 802, a third MIMO RF power harvester component 804, and a fourth MIMO RF power harvester component 806, in accordance with the present disclosure. In some aspects, the first MIMO RF power harvester component 800, the second MIMO RF power harvester component 802, the third MIMO RF power harvester component 804, and/or the fourth MIMO RF power harvester component 806 may be included in a UE (e.g., the UE 120).

FIGS. 8A and 8B illustrate, respectively, the first MIMO RF power harvester component 800 and the second MIMO RF power harvester component 802, each of which may be implemented as a passive device or a semi-passive device. In some aspects, the first MIMO RF power harvester component 800 and the second MIMO RF power harvester component 802 may include common components, which are shown through the use of a same designator number. For brevity, description of the common components is provided with reference to the first MIMO RF power harvester component 800, but is also applicable to the second MIMO RF power harvester component 802.

The first MIMO RF power harvester component 800 may electrically couple to multiple antennas 808 that are shown as including N antennas. In some aspects, the multiple antennas 808 may be included as part of the first MIMO RF power harvester component 800, while in other examples, the multiple antennas 808 may be external to the first MIMO RF power harvester component 800. As shown by FIG. 8A, the first MIMO RF power harvester component 800 may receive N input signals (shown as y₁ to y_{N}).

The first MIMO RF power harvester component 800 may include multiple power splitter components 810 (e.g., N power splitter components), and the multiple power splitter components 810 may be implemented as any combination of one or more passive devices and/or one or more semi-passive devices. In some aspects, a power splitter component may partition an input signal into multiple output signals. To illustrate, a first power splitter component of the multiple power splitter components 810 may electrically couple to a first antenna of the multiple antennas 808 (e.g., based at least in part on a one-to-one connection), and a second power splitter of the multiple power splitter components 810 may electrically couple to a second antenna of the multiple antennas 808 (e.g., based at least in part on a one-to-one connection). As shown by FIG. 8A and reference number 812, the first power splitter component may receive a first input signal (e.g., y₁) and partition the first input signal into L output signals, where L is an integer. For instance, the first power splitter component may partition the first input signal into a first output signal α₁y₁, a second output signal α₂y₂, up to an L-th output signal α_{L}y₁, where α₁, α₂, and ar indicate a scaling factor that is applied to the input signal y₁.

In some aspects, the first power splitter component may split an input signal into L respective output signals based at least in part on static and/or fixed partitioning (e.g., partition sizes that remain constant). The first power splitter component may split the input signal into equal partitions, or non-equal partitions. Alternatively, the first power splitter component may split the input signal into L respective output signals based at least in part on dynamic partitioning. To illustrate, the first power splitter component may be electrically coupled to an energy meter component as described with regard to FIGS. 5 and 7B, and may receive input from the energy meter component that indicates that a rectifier component has reached a saturation level. The first power splitter component may adjust how the input signal is partitioned to reduce an input power at the rectifier component. Alternatively or additionally, the first power splitter component may adjust the partitioning based at least in part on applying a first combination of signal splitting factors to the input signal that result in a higher power level at a battery relative to a second combination of signal splitting factors. That is, the first power splitter component may adjust the partitioning based at least in part on a change (e.g., power level change) in one or more input signals to optimally capture power from the input signals.

The first MIMO RF power harvester component 800 may include multiple rectifier components 814, and each rectifier component may include multiple rectifier inputs. In some aspects, each power splitter component of the multiple power splitter components 810 may be electrically coupled to each rectifier component of the multiple rectifier components 814. For instance, a first combiner output of a first power splitter component may electrically couple to a rectifier input of a first rectifier component, a second combiner output of the first power splitter component may electrically couple to a rectifier input of a second rectifier component, up to an L-th combiner output of the first power splitter component that may electrically couple to a rectifier input of an L-th rectifier component. Accordingly, each power splitter component of the multiple power splitter components 810 may electrically couple to each rectifier component of the multiple rectifier components 814.

As shown by FIG. 8B, reference number 816-1, and reference number 816-2, the first power splitter component of the multiple power splitter components 810 may split an input signal into less than L partitions, where L is associated with a number of rectifier components included in the second MIMO RF power harvester component 802. That is, a power splitter component may electrically connect to a subset of rectifier components included in the multiple rectifier components 814. To illustrate, and as shown by reference number 816-1, a first power splitter component of the multiple power splitter components 810 may be electrically coupled to each rectifier component in a first subset of rectifier components and/or may be electrically disconnected from at least one rectifier component in a second subset of rectifier components. A K-th power splitter component may be electrically coupled to each rectifier component in the second subset of rectifier components and electrically disconnected from at least one rectifier component in the first subset of rectifier components, as shown by reference number 816-2.

As shown by FIG. 8A, each rectifier component of the multiple rectifier components 814 may electrically couple to a battery 818, which may be internal or external to the first MIMO RF power harvester component 800. As described above, the battery may be a rechargeable battery that provides power to a component within the first MIMO RF power harvester component 800 and/or a component external to the first MIMO RF power harvester component 800.

FIGS. 8C and 8D illustrate, respectively, the third MIMO RF power harvester component 804 and the fourth MIMO RF power harvester component 806, each of which may be implemented as a passive device or a semi-passive device. In some aspects, the third MIMO RF power harvester component 804 and the fourth MIMO RF power harvester component 806 may include common components, which are shown through the use of a same designator number. For brevity, description of the common components is provided with reference to the third MIMO RF power harvester component 804, but also is applicable to the fourth MIMO RF power harvester component 806.

FIG. 8C illustrates the third MIMO RF power harvester component 804. The third MIMO RF power harvester component 804 may electrically couple to multiple antennas that are grouped into K antenna groups, such as a first antenna group 820-1 up to a K-th antenna group 820-K. Each antenna group may include a same number of antennas as other antenna groups, or a different number of antennas from other antenna groups. Alternatively, or additionally, each antenna group may include one or more antennas that are grouped together based at least in part on one or more common characteristics, such as a common operating frequency band, a common operating center frequency, and/or a common polarization.

The third MIMO RF power harvester component 804 may include multiple power splitter components 822 (e.g., K power splitter components), and the multiple power splitter components 822 may be implemented as any combination of one or more passive devices and/or one or more semi-passive devices. As shown by FIG. 8C, each power splitter component of the multiple power splitter components 822 may be electrically coupled to a respective antenna group. To illustrate, a first power splitter component of the multiple power splitter components 822 may include multiple power splitter inputs, and each power splitter input of the first power splitter component may be electrically coupled to a respective antenna of the first antenna group 820-1.

In some aspects, and as shown by reference number 824, the first power splitter component may generate a combined signal based at least in part on each received signal from each respective antenna, and split and/or partition the combined signal into multiple output signals (shown as L output signals). Alternatively or additionally, the first power splitter component may split and/or partition each received signal independently of other received signals. To illustrate, the first antenna group may include M antennas, the first power splitter component may include M splitter inputs (e.g., each splitter input being electrically coupled to a respective antenna in the first antenna group), and the first power splitter component may include L splitter outputs. The first power splitter component may receive a first signal from a first antenna in the first antenna group, a second signal from a second antenna in the first antenna group, and an M-th signal from an M-th antenna in the first antenna group. In some aspects, the first power splitter component may split each signal from each antenna in the first antenna group into L partitions. That is, the first power splitter component may partition the first signal into L partitions, the second signal into L partitions, and the M-th signal into L partitions (resulting in M partitioned signals, each partition signal including L partitions). The first power splitter component may split the input signal into L respective output signals based at least in part on static partitioning or dynamic partitioning, as described above.

In some aspects, the first power splitter component may generate L combined signals based at least in part on using a respective partition from each of the M partitioned signals. For instance, the first power splitter component may generate a first combined signal based at least in part on combining a first partition of the first signal, a first partition of the second signal, and an L-th partition of the M-th signal. As shown by reference number 824, the first power splitter component may electrically couple to each rectifier component of multiple rectifier components 826 included in the third MIMO RF power harvester component 804. That is, the first power splitter component may output a respective combined signal on a respective combiner output that is electrically coupled to a rectifier component based at least in part on a one-to-one connection. Accordingly, each power splitter component of the multiple power splitter components 822 may electrically couple to each rectifier component of the multiple rectifier components 826.

As shown by FIG. 8D, reference number 828-1 and reference number 828-2, the first power splitter component of the multiple power splitter component may split an input signal into less than L partitions, where L is associated with a number of rectifier components included in the fourth MIMO RF power harvester component 806. That is, a power splitter component may electrically connect to a subset of rectifier components included in the multiple rectifier components 826. To illustrate, and as shown by reference number 828-1, a first power splitter component of the multiple power splitter components 822 may be electrically coupled to each rectifier component in a first subset of rectifier components and/or may be electrically disconnected from at least one rectifier component in a second subset of rectifier components. A K-th power splitter component may be electrically coupled to each rectifier component in the second subset of rectifier components and electrically disconnected from at least one rectifier component in the first subset of rectifier components, as shown by reference number 828-2.

As shown by FIG. 8C, each rectifier component of the multiple rectifier components 826 may electrically couple to a battery 830, which may be internal or external to the third MIMO RF power harvester component 804. As described above, the battery 830 may be a rechargeable battery that provides power to a component within the third MIMO RF power harvester component 804 and/or a component external to the third MIMO RF power harvester component 804.

By receiving input signals based at least in part on multiple antennas, a MIMO RF power harvester may generate a combined signal that has a higher PAPR relative to a single antenna. An ability to partition and/or modify an input signal may enable the MIMO RF power harvester to adjust signals in a manner that increases an amount of power extracted by the MIMO RF power harvester (e.g., by selecting optimal modifications that generate a combined signal that best extracts power relative to other combined signals associated with other modifications). Accordingly, the combined signal may enable a passive UE to harvest power and/or energy in wireless communications systems that operate at higher frequencies (e.g., that may be more susceptible to multi-path fading) and/or increase an operating range of the passive UE from the network node.

As indicated above, FIGS. 8A, 8B, 8C, and 8D are provided as examples. Other examples may differ from what is described with regard to FIGS. 8A, 8B, 8C, and 8D.

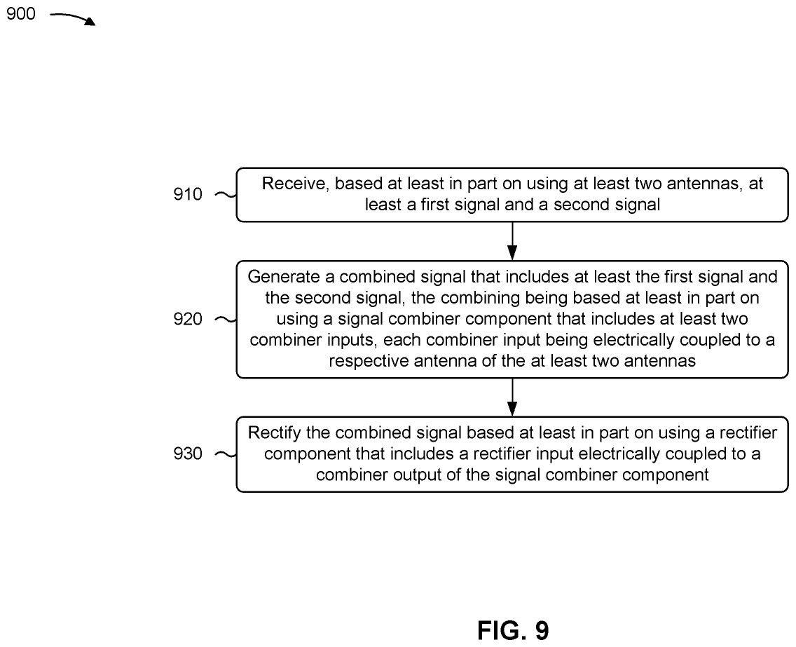

FIG. 9 is a diagram illustrating an example process 900 performed, for example, by an apparatus, in accordance with the present disclosure. Example process 900 is an example where the apparatus (e.g., MIMO RF power harvester component 402 or MIMO RF power harvester component 502) performs operations associated with a MIMO RF power harvester

As shown in FIG. 9, in some aspects, process 900 may include receiving, based at least in part on using at least two antennas, at least a first signal and a second signal (block 910). For example, the apparatus may receive, based at least in part on using at least two antennas (e.g., the antennas 404 or the antennas 504), at least a first signal and a second signal, as described above.

As further shown in FIG. 9, in some aspects, process 900 may include generating a combined signal that includes at least the first signal and the second signal, the generating being based at least in part on using a signal combiner component that includes at least two combiner inputs, each combiner input being electrically coupled to a respective antenna of the at least two antennas (block 920). For example, the apparatus may generate a combined signal that includes at least the first signal and the second signal based at least in part on using a signal combiner component (e.g., the signal combiner component 408 or the signal combiner component 508) that includes at least two combiner inputs, each combiner input being electrically coupled to a respective antenna of the at least two antennas, as described above.

As further shown in FIG. 9, in some aspects, process 900 may include rectifying the combined signal based at least in part on using a rectifier component that includes a rectifier input electrically coupled to a combiner output of the signal combiner component (block 930). For example, the apparatus may rectify the combined signal based at least in part on using a rectifier component (e.g., the rectifier component 412 or the rectifier component 512) that includes a rectifier input electrically coupled to a combiner output of the signal combiner component, as described above.

Process 900 may include additional aspects, such as any single aspect or any combination of aspects described below and/or in connection with one or more other processes described elsewhere herein.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

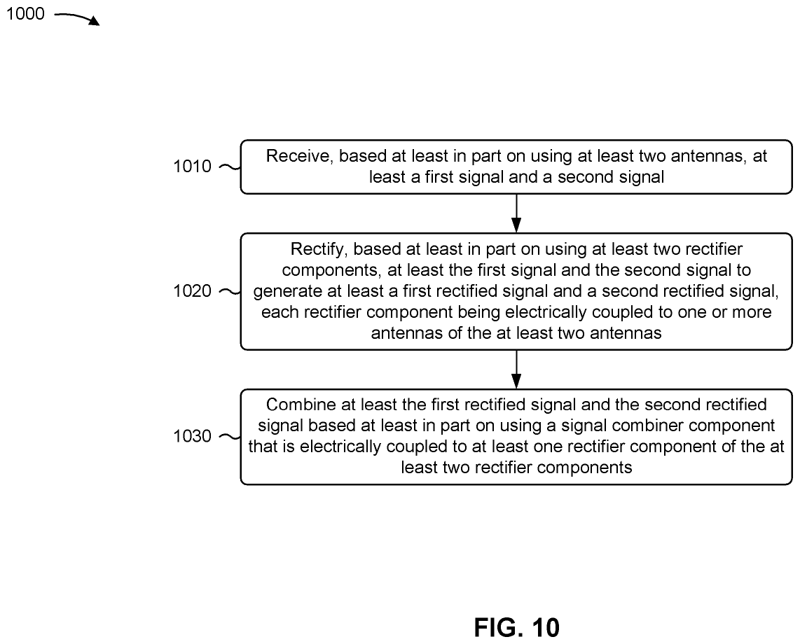

FIG. 10 is a diagram illustrating an example process 1000 performed, for example, by an apparatus, in accordance with the present disclosure. Example process 1000 is an example where the apparatus (e.g., the MIMO RF power harvester component 602, the MIMO RF power harvester component 700, or the MIMO RF power harvester component 702) performs operations associated with a MIMO RF power harvester.

As shown in FIG. 10, in some aspects, process 1000 may include receiving, based at least in part on using at least two antennas, at least a first signal and a second signal (block 1010). For example, the apparatus may receive, based at least in part on using at least two antennas (e.g., using the antennas 604, the antennas 704-1 to 704-K, or the antennas 712-1 to 712-K), at least a first signal and a second signal, as described above.

As further shown in FIG. 10, in some aspects, process 1000 may include rectifying, based at least in part on using at least two rectifier components, at least the first signal and the second signal to generate at least a first rectified signal and a second rectified signal, each rectifier component being electrically coupled to one or more antennas of the at least two antennas (block 1020). For example, the apparatus (e.g., using the rectifier components 608-1 to 608-N, the rectifier components 706-1 to 706-K, or the rectifier components 716-1 to 716-K) may rectify, based at least in part on using at least two rectifier components, at least the first signal and the second signal to generate at least a first rectified signal and a second rectified signal, each rectifier component being electrically coupled to one or more antennas of the at least two antennas, as described above.

As further shown in FIG. 10, in some aspects, process 1000 may include combining at least the first rectified signal and the second rectified signal based at least in part on using a signal combiner component that is electrically coupled to at least one rectifier component of the at least two rectifier components (block 1030). For example, the apparatus may combine at least the first rectified signal and the second rectified signal based at least in part on using a signal combiner component (e.g., the signal combiner component 612, the signal combiner component 708, the signal combiner components 714-1 to 714-K, and/or the signal combiner component 718) that is electrically coupled to at least one rectifier component of the at least two rectifier components, as described above.

Process 1000 may include additional aspects, such as any single aspect or any combination of aspects described below and/or in connection with one or more other processes described elsewhere herein.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

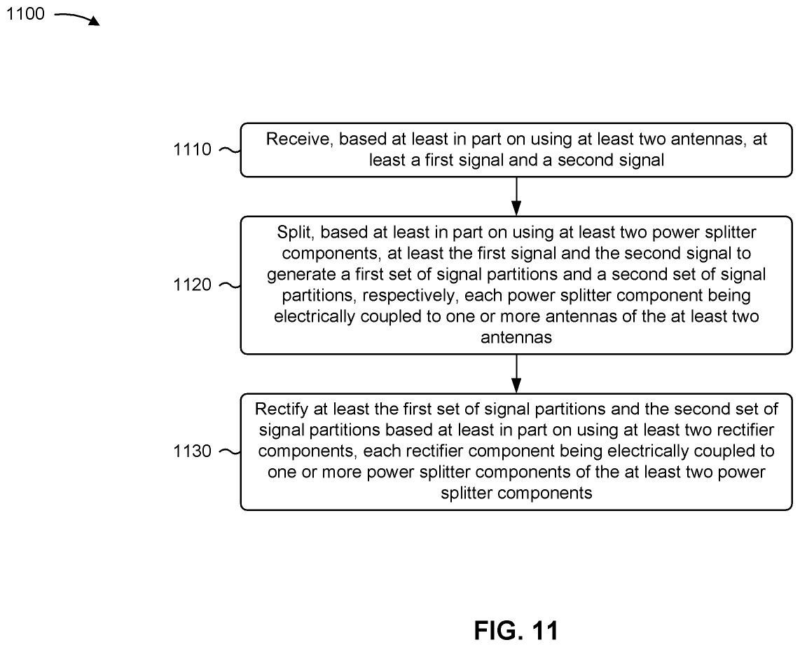

FIG. 11 is a diagram illustrating an example process 1100 performed, for example, by an apparatus, in accordance with the present disclosure. Example process 1100 is an example where the apparatus (e.g., the first MIMO RF power harvester component 800, the second MIMO RF power harvester component 802, the third MIMO RF power harvester component 804, or the fourth MIMO RF power harvester component 806) performs operations associated with a MIMO RF power harvester.

As shown in FIG. 11, in some aspects, process 1100 may include receiving, based at least in part on using at least two antennas, at least a first signal and a second signal (block 1110). For example, the apparatus may receive, based at least in part on using at least two antennas (e.g., the multiple antennas 808, the first antenna group 820-1, and/or the K-th antenna group 820-K), at least a first signal and a second signal, as described above.

As further shown in FIG. 11, in some aspects, process 1100 may include splitting, based at least in part on using at least two power splitter components, at least the first signal and the second signal to generate a first set of signal partitions and a second set of signal partitions, respectively, each power splitter component being electrically coupled to one or more antennas of the at least two antennas (block 1120). For example, the apparatus may split, based at least in part on using at least two power splitter components (e.g., the multiple power splitter components 810 or the multiple power splitter components 822), at least the first signal and the second signal to generate a first set of signal partitions and a second set of signal partitions, respectively, each power splitter component being electrically coupled to one or more antennas of the at least two antennas, as described above.

As further shown in FIG. 11, in some aspects, process 1100 may include rectifying at least the first set of signal partitions and the second set of signal partitions based at least in part on using at least two rectifier components, each rectifier component being electrically coupled to one or more power splitter components of the at least two power splitter components (block 1130). For example, the apparatus may rectify at least the first set of signal partitions and the second set of signal partitions based at least in part on using at least two rectifier components (e.g., the multiple rectifier components 814 or the multiple rectifier components 826), each rectifier component being electrically coupled to one or more power splitter components of the at least two power splitter components, as described above.

Process 1100 may include additional aspects, such as any single aspect or any combination of aspects described below and/or in connection with one or more other processes described elsewhere herein.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

The following provides an overview of some Aspects of the present disclosure:
Aspect 1: An apparatus comprising: at least two antennas; a signal combiner component that includes at least two combiner inputs, each combiner input being electrically coupled to a respective antenna of the at least two antennas; and a rectifier component that includes a rectifier input electrically coupled to a combiner output of the signal combiner component.
Aspect 2: The apparatus of Aspect 1, further comprising: a rechargeable battery that includes a battery input that is electrically coupled to a rectifier output of the rectifier component.
Aspect 3: The apparatus of Aspect 1 or Aspect 2, wherein the signal combiner component is configured to: receive, from each antenna of the at least two antennas, a respective signal from the antenna based at least in part on electrically coupling the antenna to a respective combiner input of the at least two combiner inputs; combine each respective signal together to generate a combined signal; and output the combined signal based at least in part on using the combiner output.
Aspect 4: The apparatus of any one of Aspects 1-3, wherein the signal combiner component is configured to: receive, from each antenna of the at least two antennas, a respective signal from the antenna based at least in part on electrically coupling the antenna to a respective combiner input of the at least two combiner inputs; generate, for each respective signal, a respective modified signal; combine the respective modified signal with one or more other modified signals to generate a combined signal; and output the combined signal based at least in part on using the combiner output.
Aspect 5: The apparatus of Aspect 4, further comprising: an energy meter that includes: an energy meter input that is electrically coupled to a rectifier output of the rectifier component; and an energy meter output that is electrically coupled to one combiner input of the at least two combiner inputs, wherein the signal combiner component is configured to generate the respective modified signal based at least in part on the energy meter output.
Aspect 6: The apparatus of Aspect 4 or Aspect 5, wherein the signal combiner component is configured to generate the respective modified signal based at least in part on at least one of: a non-complex scaling factor, a complex scaling factor, or a phase factor.
Aspect 7: The apparatus of any one of Aspects 4-6, wherein the signal combiner component is configured to generate the respective modified signal based at least in part on a user equipment capability.
Aspect 8: The apparatus of any one of Aspects 4-7, wherein the signal combiner component, to combine the respective modified signal with the one or more other modified signals, is configured to perform at least one of: non-coherent combining, coherent combining, or diversity combining.
Aspect 9: The apparatus of any one of Aspects 4-8, wherein the signal combiner component, to generate the respective modified signal, is further configured to: select a respective modification for the respective signal based at least in part on optimizing a power level of the combined signal.
Aspect 10: The apparatus of Aspect 9, wherein the apparatus further comprises: an energy meter that includes: an energy meter input that is electrically coupled to a rectifier output of the rectifier component; and an energy meter output that is electrically coupled to one combiner input of the at least two combiner inputs, wherein the signal combiner component is configured to select the respective modification based at least in part on the energy meter output.
Aspect 11: An apparatus comprising: at least two antennas; at least two rectifier components, each rectifier component being electrically coupled to one or more antennas of the at least two antennas; and a signal combiner component that is electrically coupled to at least one rectifier component of the at least two rectifier components.
Aspect 12: The apparatus of Aspect 11 further comprising: a rechargeable battery that includes a battery input that is electrically coupled to a combiner output of the signal combiner component.
Aspect 13: The apparatus of Aspect 11 or Aspect 12, wherein, for each antenna of the at least two antennas, the antenna is electrically coupled to a rectifier input of a respective rectifier component of the at least two rectifier components.
Aspect 14: The apparatus of any one of Aspects 11-13, further comprising at least one signal filter, wherein at least one rectifier component is electrically coupled to an antenna of the at least two antennas based at least in part on the at least one signal filter.
Aspect 15: The apparatus of Aspect 14, wherein the at least two antennas comprise at least one of: a narrowband antenna or a wideband antenna, wherein the at least two rectifier components comprise at least one of: a narrowband rectifier component or a wideband rectifier component, and wherein the at least one signal filter is based at least in part on at least one of: the narrowband antenna, the narrowband rectifier component, the wideband antenna, or the wideband rectifier component.
Aspect 16: The apparatus of Aspect 15, wherein the at least two antennas comprise a first antenna configured for a first frequency band and a second antenna configured for a second, different frequency band.
Aspect 17: The apparatus of Aspect 15 or Aspect 16, wherein the at least two rectifier components comprise a first rectifier component configured for a first frequency band and a second rectifier component configured for a second, different frequency band.
Aspect 18: The apparatus of any one of Aspects 11-17, wherein the signal combiner component comprises at least two combiner inputs, and wherein each combiner input of the at least two combiner inputs is electrically coupled to a rectifier output of a respective rectifier component of the at least two rectifier components.
Aspect 19: The apparatus of any one of Aspects 11, wherein the signal combiner component comprises at least two combiner inputs, wherein the at least two antennas comprise at least a first antenna group and a second antenna group, wherein the first antenna group is electrically coupled to a first rectifier component of the at least two rectifier components, and wherein the second antenna group is electrically coupled to a second rectifier component of the at least two rectifier components.
Aspect 20: The apparatus of Aspect 19, wherein the first rectifier component comprises multiple rectifier inputs, and wherein, for each antenna of the first antenna group, the antenna is electrically coupled to a respective rectifier input of the multiple rectifier inputs.
Aspect 21: The apparatus of Aspect 19 or Aspect 20, wherein the first antenna group or the second antenna group are grouped based at least in part on at least one of: a common operating frequency band, a common operating center frequency, or a common polarization.
Aspect 22: The apparatus of any one of Aspects 19-21, wherein the signal combiner component comprises at least: a first combiner input that is electrically coupled to a first rectifier output of the first rectifier component, and a second combiner input that is electrically coupled to a second rectifier output of the second rectifier component.
Aspect 23: The apparatus of Aspect 19, wherein the signal combiner component is a first signal combiner component, wherein the first antenna group is electrically coupled to the first rectifier component based at least in part on the first signal combiner component being electrically coupled to the first antenna group and the first rectifier component, and wherein the second antenna group is electrically coupled to the second rectifier component based at least in part on a second signal combiner component that is electrically coupled to the second antenna group and the second signal combiner component.
Aspect 24: The apparatus of Aspect 23, wherein, for each antenna of the first antenna group, the antenna is electrically coupled to a respective combiner input of the at least two combiner inputs of the first signal combiner component, and wherein a combiner output of the first signal combiner component is electrically coupled to a rectifier input of the first rectifier component.
Aspect 25: The apparatus of Aspect 24, further comprising an energy meter that is electrically coupled to at least the first signal combiner component, wherein the first signal combiner component generates a signal output based at least in part on an input from the energy meter.
Aspect 26: The apparatus of Aspect 23, wherein the first signal combiner component comprises more processing functionality relative to a third combiner component, and wherein the third combiner component generates a combined signal based at least in part on: a first rectifier signal output associated with the first rectifier component, and a second rectifier signal output associated with the second rectifier component.
Aspect 27: An apparatus comprising: at least two antennas; at least two power splitter components, each power splitter component being electrically coupled to one or more antennas of the at least two antennas; and at least two rectifier components, each rectifier component being electrically coupled to one or more power splitter components.
Aspect 28: The apparatus of Aspect 27 further comprising: a rechargeable battery that is electrically coupled to a respective rectifier output of each rectifier component of the at least two rectifier components.
Aspect 29: The apparatus of Aspect 27 or Aspect 28, wherein a first antenna of the at least two antennas is electrically coupled to a first power splitter component of the at least two power splitter components based at least in part on a first one-to-one connection, and wherein a second antenna of the at least two antennas is electrically coupled to a second power splitter component of the at least two power splitter components based at least in part on a second one-to-one connection.
Aspect 30: The apparatus of any one of Aspects 27-29, wherein the at least two antennas comprise at least a first antenna group and a second antenna group, wherein each antenna in the first antenna group is electrically coupled to a first power splitter component of the at least two power splitter components, and wherein each antenna in the second antenna group is electrically coupled to a second power splitter component of the at least two power splitter components.
Aspect 31: The apparatus of any one of Aspects 27-30, wherein each power splitter component of the at least two power splitter components is electrically coupled to each rectifier component of the at least two rectifier components.
Aspect 32: The apparatus of any one of Aspects 27-30, wherein the at least two rectifier components comprise at least a first subset of rectifier components and a second subset of rectifier components, wherein a first power splitter component of the at least two power splitter components is electrically coupled to each rectifier component in the first subset of rectifier components and is electrically disconnected from at least one rectifier component in the second subset of rectifier components, and wherein a second power splitter component of the at least two power splitter components is electrically coupled to each rectifier component in the second subset of rectifier components and is electrically disconnected from at least one rectifier component in the first subset of rectifier components.
Aspect 33: The apparatus of any one of Aspects 27-32, wherein each power splitter component of the at least two power splitter components comprises: a splitter input configured to receive an input signal; and multiple splitter outputs, each splitter output configured to output a respective splitter output signal that is based at least in part on the input signal.
Aspect 34: The apparatus of Aspect 33, wherein the multiple splitter outputs comprise L outputs, L being an integer, and wherein at least one power splitter component of the at least two power splitter components is configured to: split the input signal into/respective output signals based at least in part on static partitioning; and output each output signal of the L respective output signals on a respective splitter output of the multiple splitter outputs.
Aspect 35: The apparatus of Aspect 33, wherein the multiple splitter outputs comprise L outputs, L being an integer, and wherein at least one power splitter component of the at least two power splitter components is configured to: split the input signal into L respective output signals based at least in part on dynamic partitioning; and output a respective output signal on a respective splitter output of the multiple splitter outputs.
Aspect 36: The apparatus of Aspect 35, wherein the dynamic partitioning is based at least in part on a saturation level associated with a rectifier component of the at least two rectifier components.
Aspect 37: The apparatus of Aspect 35 or Aspect 36, further comprising: an energy meter component that is electrically coupled to the at least one power splitter component, wherein the dynamic partitioning is based at least in part on an input from the energy meter component.
Aspect 38: The apparatus of any one of Aspects 35-37, wherein the dynamic partitioning is based at least in part on a first combination of signal splitting factors that result in a higher power level at a battery relative to a second combination of signal splitting factors.
Aspect 39: The apparatus of Aspect 27, wherein the at least two antennas comprise at least a first antenna group and a second antenna group, wherein the first antenna group is electrically coupled to a first power splitter component of the at least two power splitter components, and wherein the second antenna group is electrically coupled to a second power splitter component of the at least two power splitter components.
Aspect 40: The apparatus of Aspect 39, wherein the first antenna group or the second antenna group are grouped based at least in part on at least one of: a common operating frequency band, a common operating center frequency, or a common polarization.
Aspect 41: The apparatus of Aspect 39 or Aspect 40, wherein the first power splitter component is further configured to: generate a combined signal based at least in part on each respective signal from each antenna of the first antenna group; and partition the combined signal into L output signals.
Aspect 42: The apparatus of Aspect 39 or Aspect 40, wherein the first antenna group comprises M antennas, M being a first integer, wherein the first power splitter component comprises M splitter inputs and L splitter outputs, L being a second integer, wherein, for each splitter input of the M splitter inputs, the splitter input is electrically coupled to a respective antenna of the first antenna group, and wherein the first power splitter component is further configured to: split a respective signal from each antenna of the first antenna group into L partitions to generate M partitioned signals; generate L combined signals based at least in part on using a respective partition from each of the M partitioned signals; and output a respective combined signal on a respective splitter output of the L splitter outputs.
Aspect 43: A method comprising: receiving, based at least in part on using at least two antennas, at least a first signal and a second signal; generating a combined signal that includes at least the first signal and the second based at least in part on using a signal combiner component that includes at least two combiner inputs, each combiner input being electrically coupled to a respective antenna of the at least two antennas; and rectifying the combined signal based at least in part on using a rectifier component that includes a rectifier input electrically coupled to a combiner output of the signal combiner component.
Aspect 44: A method comprising: receiving, based at least in part on using at least two antennas, at least a first signal and a second signal; rectifying, based at least in part on using at least two rectifier components, at least the first signal and the second signal to generate at least a first rectified signal and a second rectified signal, each rectifier component being electrically coupled to one or more antennas of the at least two antennas; and combining at least the first rectified signal and the second rectified signal based at least in part on using a signal combiner component that is electrically coupled to at least one rectifier component of the at least two rectifier components.
Aspect 45: A method comprising: receiving, based at least in part on using at least two antennas, at least a first signal and a second signal; splitting, based at least in part on using at least two power splitter components, at least the first signal and the second signal to generate a first set of signal partitions and a second set of signal partitions, respectively, each power splitter component being electrically coupled to one or more antennas of the at least two antennas; and rectifying at least the first set of signal partitions and the second set of signal partitions based at least in part on using at least two rectifier components, each rectifier component being electrically coupled to one or more power splitter components of the at least two power splitter components.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. An apparatus comprising:
at least two antennas;
a signal combiner component that includes at least two combiner inputs, each combiner input being electrically coupled to a respective antenna of the at least two antennas; and
a rectifier component that includes a rectifier input electrically coupled to a combiner output of the signal combiner component.

2. The apparatus of claim 1, further comprising:
a rechargeable battery that includes a battery input that is electrically coupled to a rectifier output of the rectifier component.

3. The apparatus of claim 1, wherein the signal combiner component is configured to:
receive, from each antenna of the at least two antennas, a respective signal from the antenna based at least in part on electrically coupling the antenna to a respective combiner input of the at least two combiner inputs;
combine each respective signal together to generate a combined signal; and
output the combined signal based at least in part on using the combiner output.

4. The apparatus of claim 1, wherein the signal combiner component is configured to:
receive, from each antenna of the at least two antennas, a respective signal from the antenna based at least in part on electrically coupling the antenna to a respective combiner input of the at least two combiner inputs;
generate, for each respective signal, a respective modified signal;
combine the respective modified signal with one or more other modified signals to generate a combined signal; and
output the combined signal based at least in part on using the combiner output.

5. The apparatus of claim 4, further comprising:
an energy meter that includes:
an energy meter input that is electrically coupled to a rectifier output of the rectifier component; and
an energy meter output that is electrically coupled to one combiner input of the at least two combiner inputs,
wherein the signal combiner component is configured to generate the respective modified signal based at least in part on the energy meter output.

6. The apparatus of claim 4, wherein the signal combiner component, to generate the respective modified signal, is further configured to:
select a respective modification for the respective signal based at least in part on optimizing a power level of the combined signal.

7. The apparatus of claim 6, wherein the apparatus further comprises:
an energy meter that includes:
an energy meter input that is electrically coupled to a rectifier output of the rectifier component; and
an energy meter output that is electrically coupled to one combiner input of the at least two combiner inputs,
wherein the signal combiner component is configured to select the respective modification based at least in part on the energy meter output.

8. An apparatus comprising:
at least two antennas;
at least two rectifier components, each rectifier component being electrically coupled to one or more antennas of the at least two antennas; and
a signal combiner component that is electrically coupled to at least one rectifier component of the at least two rectifier components.

9. The apparatus of claim 8 further comprising:
a rechargeable battery that includes a battery input that is electrically coupled to a combiner output of the signal combiner component.

10. The apparatus of claim 8, wherein, for each antenna of the at least two antennas, the antenna is electrically coupled to a rectifier input of a respective rectifier component of the at least two rectifier components.

11. The apparatus of claim 8, further comprising at least one signal filter, wherein at least one rectifier component is electrically coupled to an antenna of the at least two antennas based at least in part on the at least one signal filter.

12. The apparatus of claim 8, wherein the signal combiner component comprises at least two combiner inputs, and
wherein each combiner input of the at least two combiner inputs is electrically coupled to a rectifier output of a respective rectifier component of the at least two rectifier components.

13. The apparatus of claim 8, wherein the signal combiner component comprises at least two combiner inputs,
wherein the at least two antennas comprise at least a first antenna group and a second antenna group,
wherein the first antenna group is electrically coupled to a first rectifier component of the at least two rectifier components, and
wherein the second antenna group is electrically coupled to a second rectifier component of the at least two rectifier components.

14. The apparatus of claim 13, wherein the first rectifier component comprises multiple rectifier inputs, and
wherein, for each antenna of the first antenna group, the antenna is electrically coupled to a respective rectifier input of the multiple rectifier inputs.

15. The apparatus of claim 13 wherein the signal combiner component comprises at least:
a first combiner input that is electrically coupled to a first rectifier output of the first rectifier component, and
a second combiner input that is electrically coupled to a second rectifier output of the second rectifier component.

16. The apparatus of claim 13, wherein the signal combiner component is a first signal combiner component,
wherein the first antenna group is electrically coupled to the first rectifier component based at least in part on the first signal combiner component being electrically coupled to the first antenna group and the first rectifier component, and
wherein the second antenna group is electrically coupled to the second rectifier component based at least in part on a second signal combiner component that is electrically coupled to the second antenna group and the second signal combiner component.

17. The apparatus of claim 16, wherein, for each antenna of the first antenna group, the antenna is electrically coupled to a respective combiner input of the at least two combiner inputs of the first signal combiner component, and
wherein a combiner output of the first signal combiner component is electrically coupled to a rectifier input of the first rectifier component.

18. An apparatus comprising:
at least two antennas;
at least two power splitter components, each power splitter component being electrically coupled to one or more antennas of the at least two antennas; and
at least two rectifier components, each rectifier component being electrically coupled to one or more power splitter components.

19. The apparatus of claim 18 further comprising:
a rechargeable battery that is electrically coupled to a respective rectifier output of each rectifier component of the at least two rectifier components.

20-30. (canceled)
